(19) United States
(12) Patent Application Publication
(10) Pub. No.: US 2026/0349835 A1
(43) Pub. Date: Nov. 5, 2026

(54) HARDWARE-ENABLED CLOUD AUTOMATION PLATFORM AND A METHOD FOR DISTRIBUTED TASK EXECUTION AND EXTERNAL DELEGATION

(71) Applicant: Trianz Digital Consulting Private Limited, Bangalore South, Karnataka (IN)

(72) Inventors: Anil Kumar Gupta, Bangalore South (IN); Kalpana Mandloi, Bangalore South (IN); Musunuri Balaram Prasad, Bangalore South (IN); Jayaganesh K, Bangalore South (IN); Sanil Raj K P, Bangalore South (IN)

(73) Assignee: Trianz Digital Consulting Private Limited, Bangalore South, Karnataka (IN)

(21) Appl. No.: 19/717,708

(22) Filed: Jun. 24, 2026

(30) Foreign Application Priority Data
Jul. 5, 2025 (IN) 202541064343

(51) Int. Cl. G06F 9/50; G06F 9/48

(52) U.S. Cl. CPC G06F 9/5083; G06F 9/4881

(57) ABSTRACT

The present invention addresses fragmented workflows and configuration drift in cloud automation platforms (CAP) by introducing a cloud automation platform (200). First embodiment includes a message layer (220) and admin module (240) that receives and interprets automation identifiers, dispatching commands to an automation engine (260). The engine executes tasks within isolated execution environments (280) such as containers or virtual machines, ensuring consistency and host-specific execution. A second embodiment enables controlled delegation to external systems (400) via an API plugin (300) and unidirectional connection (301), suppressing internal execution to avoid conflicts and optimize resource usage. A method (700) involves configuring platform components, receiving automation identifiers (202), interpreting commands, and executing tasks either internally or externally based on context. Technical advantages include centralized control, secure communication, scalable execution, and reduced resource consumption in hybrid environments.

### CROSS REFERENCE TO RELATED APPLICATIONS

Benefit is claimed to Indian Patent Application No. IN202541064343, filed on Jul. 5, 2025, the contents of which are incorporated by reference herein in their entirety.

### FIELD OF THE INVENTION

The present invention pertains to a cloud automation platform and an associated method for orchestrating automation tasks across distributed computing environments, more particularly, the present invention relates to a hardware-enabled cloud automation platform and a method for distributed task execution and external delegation.

### BACKGROUND OF THE INVENTION

Cloud automation platforms face challenges in orchestrating tasks across distributed and heterogeneous computing environments. These environments consist of virtual machines, containers, and bare-metal hosts with varying configurations. Coordinating automation tasks across such nodes requires centralized control to ensure consistency, reliability, and security. Absence of centralized orchestration leads to fragmented workflows, configuration drift, execution failures, and increased operational overhead.

Scalability and adaptability of automation systems in cloud-native environments present additional challenges. Dynamic workloads and infrastructure scaling demand context-aware task execution tailored to each host's requirements. This includes resource isolation, concurrent execution handling, and environment-specific dependency management. Traditional systems lack this flexibility, resulting in bottlenecks, inefficient resource utilization, and limited support for multi-tenant or role-based execution.

Integration of external automation tools introduces challenges in controlled delegation. Direct management of external systems by automation engines causes execution conflicts, redundancy, and tight coupling. Such integration complicates orchestration of hybrid workflows where external systems are more suitable for specific tasks.

Resource inefficiency arises when automation engines remain active during external task execution. Continuous resource consumption without task involvement leads to scalability and performance issues, particularly in high-load or multi-tenant environments.

Conventional cloud-automation approaches address discrete aspects, such as network-level connectivity between on-premises and cloud routing domains, debugging of robotic process automation, creation of software-automation processes, and enterprise-wide automation coordination through control-tower architectures. A need remains for a unified, message-driven platform that combines centralized command dispatch, host-level execution control, granular task orchestration across virtual machines, containers, and bare-metal hosts, and controlled delegation to external automation systems without execution conflicts. The present disclosure addresses the above-mentioned requirement.

### SUMMARY

In one aspect, the disclosure provides a cloud automation platform (200) comprising a message layer (220) configured in a network-enabled computing device (C1) having a processor (P) and a memory (m), an admin module (240) communicatively coupled to the message layer (220), an automation engine (260) configured in a computing node (N), and an execution environment (280) coupled to the automation engine (260). The message layer (220) receives an automation identifier (202), which is interpreted by the admin module (240) to dispatch a predefined command to the automation engine (260). The automation engine (260) executes one or more automation tasks (t1, t2) on one or more target hosts (290a, 290b) via the execution environment (280), providing centralized coordination across virtual machines, containers, and bare-metal hosts.

In another aspect, the automation engine (260) is configured to adapt automation workflows to host-specific requirements. The automation engine (260) supports execution within parallel computing environments (260a) and distributed computing environments (260b) and includes a task scheduler (260c) and a dependency resolution module (260d) for managing execution order. The execution environment (280) provides resource isolation through containers (282), virtual machines (284), or serverless runtimes (286), enabling concurrent execution and host-specific dependency management across heterogeneous infrastructure.

In a further aspect, the cloud automation platform (200a) includes an API plugin (300) operatively coupling the automation engine (260) with an external system (400) via a unidirectional connection (301). When an external-automation identifier (202f) is received, the API plugin (300) routes a predefined command to the external system (400), enabling controlled interaction with external automation tools while maintaining separation of execution responsibilities between the automation engine (260) and the external system (400).

In yet another aspect, the automation engine (260) incorporates a suppression mechanism that places the automation engine (260) in a non-executing state during external task execution. The suppression mechanism disables the task scheduler (260c), the dependency resolution module (260d), and execution environment provisioning logic, and locks internal execution resources including containers (282), virtual machines (284), and serverless runtimes (286). This configuration reduces resource consumption and avoids execution conflicts in multi-tenant or high-load environments.

In one aspect, the disclosure provides a method (700) for performing one or more automation tasks (t1, t2) in a network-enabled computing device (C1). The method (700) comprises configuring a message layer (220), an admin module (240), and an automation engine (260) in a memory (m) of the computing device (C1); receiving an automation identifier (202) by the message layer (220); transmitting the automation identifier (202) to the admin module (240); transmitting a predefined command to the automation engine (260); and coupling an execution environment (280) to the automation engine (260), wherein the automation engine (260) executes the automation tasks (t1, t2) on one or more target hosts (290a, 290b) based on the received command.

In another aspect, the method (701) further comprises coupling the automation engine (260) to an external system (400) via an API plugin (300) over a unidirectional connection (301). Upon determining that an automation identifier corresponds to an external automation, the method (701) facilitates execution of the automation tasks (t1, t2) by the external system (400) while maintaining the automation engine (260) in a non-executing state during the task execution, thereby enabling selective delegation of automation tasks to external systems while preserving internal execution control.

### BRIEF DESCRIPTION OF DRAWINGS

FIG. 1 shows a block diagram of a cloud automation platform, in accordance with an embodiment of the present invention;

FIG. 2 shows a schematic representation of alternative embodiments of a message layer of the cloud automation platform, in accordance with an embodiment of the present invention;

FIG. 3 shows a schematic representation of alternative embodiments of automation identifiers of the cloud automation platform, in accordance with an embodiment of the present invention;

FIG. 4 shows a schematic representation of alternative embodiments of an automation engine of the cloud automation platform, in accordance with an embodiment of the present invention;

FIG. 5 shows a schematic representation of alternative embodiments of an execution environment of the cloud automation platform, in accordance with an embodiment of the present invention;

FIG. 6 shows a schematic representation of alternative embodiments of a target host of the cloud automation platform, in accordance with an embodiment of the present invention;

FIG. 7 shows a schematic representation of a detailed view of the automation of the cloud automation platform, in accordance with an embodiment of the present invention;

FIG. 8 shows a block diagram of a further embodiment of the cloud automation platform, in accordance with an embodiment of the present invention;

FIG. 9 shows a flow chart of a method for performing automation tasks in a network-enabled computing device, in accordance with an embodiment of the present invention; and

FIG. 10 shows a flow chart of an alternative embodiment of the method for performing automation tasks in the network-enabled computing device, in accordance with the present invention.

### DETAILED DESCRIPTION

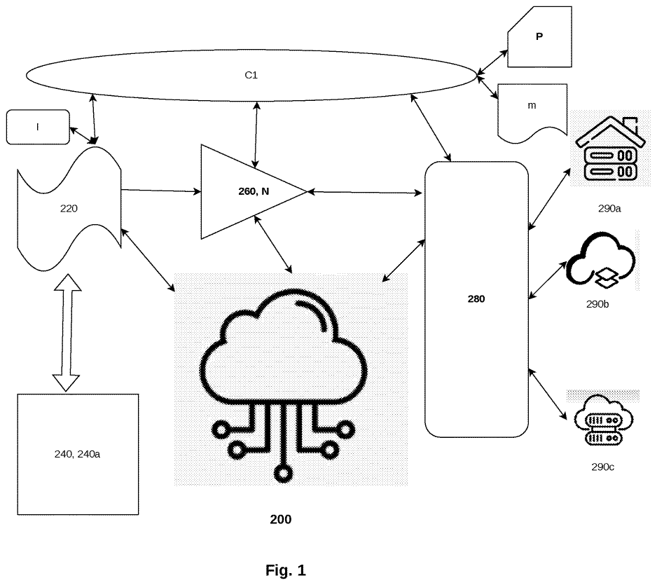

In a preferred embodiment of the present invention (FIG. 1), a Cloud Automation Platform (CAP) (200) is provided. The cloud automation platform (200) has a message layer (220), an admin module (240), an automation engine (260), an Execution Environment (EE) (280) and one or more target hosts (290a, 290b). The message layer (220) is configured in a network-enabled computing device (C1). The network-enabled computing device (C1) is a system equipped with hardware and software components that facilitate communication over digital networks. The computing device (C1) includes a processor (P) for executing instructions, and a memory (m) for storing data and applications, and a network interface (I) including an Ethernet interface, a Wi-Fi interface, or a cellular modem that enable connectivity with other systems. The computing device (C1) supports deployment of modules like message layers and admin interfaces, allowing orchestration and control of automation workflows across distributed environments.

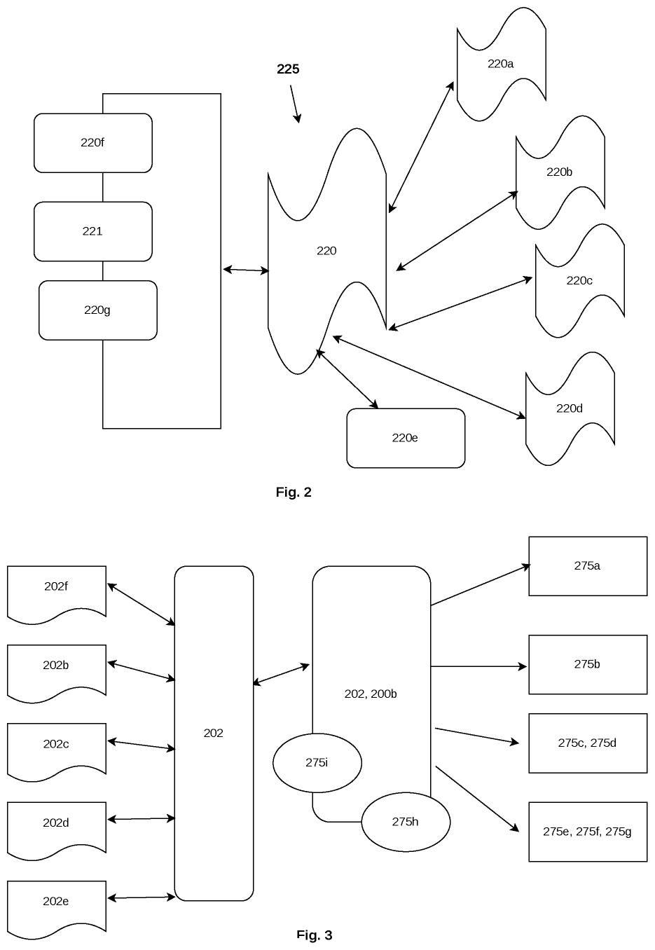

In an embodiment of the CAP (200c) (FIG. 2), the message layer (220) is implemented as a set of software components deployed within the memory (m) of a network-enabled computing device (C1). The message layer (220) interacts with the processor (P) and network interface (I) to enable asynchronous, decoupled, and real-time communication across distributed automation modules. The message layer (220) is configured to receive automation identifiers (202) and transmit the automation identifiers (202) to downstream components for orchestration and execution of automation tasks.

The message layer (220) may include one or more messaging architectures (225). The messaging architecture (225) can include a message queue (220a) that supports asynchronous and ordered transmission with lifecycle control and durable storage. The messaging architecture (225) can include a publish-subscribe system (220b) that supports decoupled broadcasting and topic-based routing. The messaging architecture (225) can include an event stream (220c) that supports real-time event capture and processing. The messaging architecture (225) can include a message bus (220d) that supports scalable, protocol-driven communication across modules. The messaging architecture (225) can include an in-memory messaging system (220e) that supports low-latency data exchange using volatile storage and lightweight brokers. By way of non-limiting example, the messaging architecture (225) may be implemented using commercially available technologies such as RabbitMQ™, Apache Kafka™, Redis™, Amazon Kinesis™, or Azure Service Bus™. The trademarks referenced herein are the property of their respective owners and are used solely to illustrate compatible commercial implementations.

The message layer (220) further includes a logic component (220f) for rule-based filtering, routing, and transformation of automation-related messages. The message layer (220) further includes a message persistence (221) and retry mechanisms (220g), which may be implemented through durable buffers, retry schedulers, and failure-handling modules. The said features ensure reliable message delivery, execution continuity, and scalable communication across distributed automation environments.

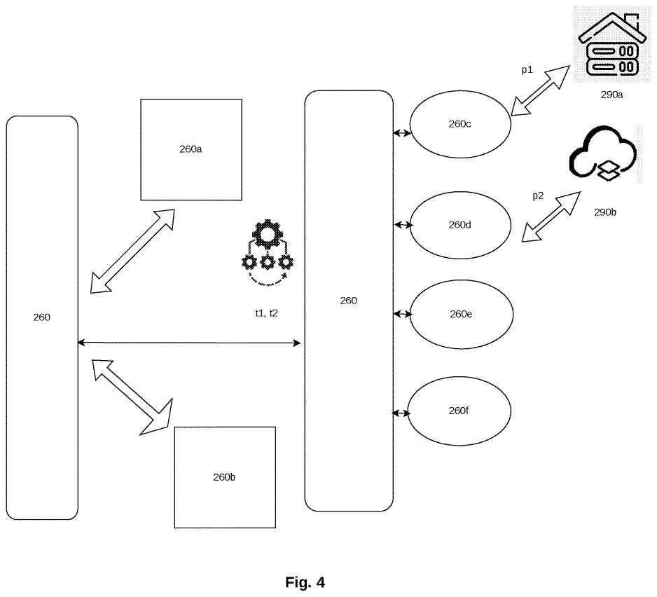

In an embodiment of the CAP (200b) (FIG. 3), the automation identifier (202) may be received from various sources within or connected to the platform (200b). These sources include a user interface (275a) with structured input components. A machine learning module (275b) may generate the automation identifiers (202) based on predictive analysis. Service outputs (275c) from computing activities (275d) such as monitoring or CI/CD pipelines may provide the automation identifiers (202). Service inputs (275e) from computing environments (275f) such as orchestration systems or deployment tools may also provide automation identifiers (202). A scheduler (275h) may generate the automation identifiers (202) based on time-based or event-driven triggers. External systems (275i) may transmit the automation identifiers (202) via APIs or service connectors (not shown). An API (275g) may provide the automation identifiers (202) through programmatic interfaces or service connectors.

The automation identifier (202) includes one or more task identifiers (202a), a workflow identifier (202b), a script reference (202c), a policy tag (202d), or a configuration profile (202e), each representing a distinct automation context. These elements enable precise execution, multi-step orchestration, script invocation, policy enforcement, and environment-specific configuration. The automation identifier (202) also carries metadata such as task priority, timestamp, and contextual information related to a user initiating the automation, supporting prioritization, scheduling, and access control. In some embodiments, an external-automation identifier (202f) may be designated separately to distinguish external delegation from internal task identifiers (202a).

These structured elements and metadata collectively enable the platform (200) to interpret, route, and execute automation tasks with precision, scalability, and compliance across heterogeneous computing environments. The message layer (220) receives and processes these identifiers using secure communication protocols, ensuring reliable orchestration across distributed modules.

The admin module (240), shown in FIG. 1 may be instantiated as a software-based control and coordination unit within the memory (m) of the computing device (C1), which may include local memory or cloud-based services such as SaaS platforms. The admin module (240) is communicatively coupled to the message layer (220) and is configured to receive the automation identifier (202). The admin module (240) includes a command dispatcher for interpreting automation identifiers (202), a task registry for mapping identifiers to predefined automation commands, and a communication interface for interacting with the message layer (220) and the automation engine (260).

In an embodiment of the CAP (200c), the admin module (240) further includes a rules engine (240a) configured to determine execution logic based on the automation identifier (202). The rules engine (240a) maintains a mapping registry that associates the automation identifiers (202) with corresponding commands. Additional components of the admin module (240) include a logging and auditing subsystem for traceability, and mechanisms for role-based access control and policy enforcement to ensure secure and authorized execution of automation workflows across distributed environments.

The automation engine (260) (FIG. 4) is configured within a dedicated computing node (N) that is connected to the processor (P), memory (m), and network interface (I) of the cloud automation platform (200). The computing node (N) is provisioned with execution resources such as CPU cores, memory blocks, and containerized runtimes to support scalable and concurrent task execution. The automation engine (260) includes components such as a task interpreter, execution scheduler, and resource allocator, which collectively enable the processing of predefined commands received from the admin module (240) and dispatch automation tasks to target hosts (290a, 290b).

The automation engine (260) may be communicatively coupled to the admin module (240) via the network interface (I), allowing secure and low-latency transmission of automation commands. Upon receiving a command corresponding to an automation identifier (202), the automation engine (260) initiates task execution within the execution environment (EE) (280). The execution environment (280) supports runtime isolation, dependency resolution, and host-specific configuration handling. The automation engine (260) also includes logging, error recovery, and performance monitoring subsystems to ensure reliable and auditable execution across distributed and heterogeneous infrastructure.

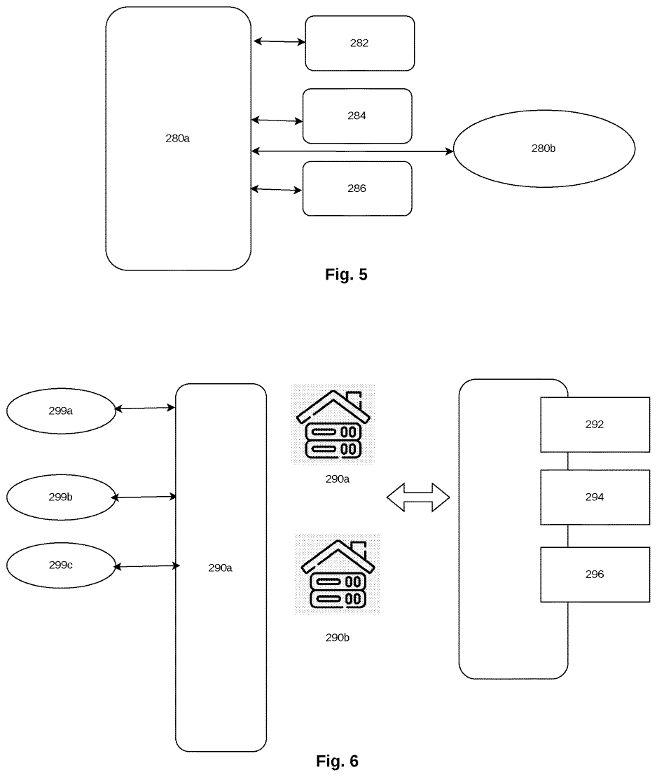

In an embodiment of the CAP (200d) (FIG. 4), the automation engine (260) is configured to execute multiple automation tasks within a parallel computing environment (260a) and a distributed computing environment (260b). The parallel computing environment (260a) includes multi-core processors, distributed memory architecture, and containerized runtimes that enable concurrent execution of automation tasks (t1, t2) across multiple threads or nodes. The said configuration supports high-throughput orchestration, reduces execution latency, and enhances scalability. The automation engine (260) leverages this parallelism to handle diverse workloads such as provisioning, patching, and deployment across heterogeneous target hosts (290a, 290b), ensuring task isolation, resource allocation, and fault tolerance through integration with the execution environment (280) (FIG. 5).

The distributed computing environment (260b) includes multiple interconnected computing nodes equipped with execution resources and network interfaces. The interconnected computing nodes collaboratively process automation tasks (t1, t2) across geographically or logically separated infrastructure, enabling fault tolerance, load balancing, and horizontal scalability. The automation engine (260) utilizes distributed task schedulers, inter-node communication protocols, and state synchronization mechanisms to coordinate execution. Examples include provisioning virtual machines across cloud regions or deploying updates to container clusters managed by orchestration platforms such as Kubernetes™ (by way of non-limiting example).

The automation engine (260) includes a task scheduler (260c) and a dependency resolution module (260d) to manage task execution within defined workflows. The task scheduler (260c) initiates tasks based on predefined criteria such as time schedules, task priorities, or system-defined triggers. The dependency resolution module (260d) analyzes task relationships to determine execution order, ensuring that dependent tasks are executed in the correct sequence. The said coordination ensures logical consistency, prevents conflicts, and supports complex automation workflows. The automation engine (260) further includes a monitoring and logging subsystem (260f) for tracking task execution status and performance metrics.

In another embodiment of the CAP (200e) (FIG. 4), the automation engine (260e) supports secure and reliable communication with the target hosts (290a, 290b) using secure remote communication protocols (p1, p2) such as Secure Shell (SSH) or Transport Layer Security (TLS), by way of non-limiting example. By supporting one or more such communication methods, the automation engine (260e) ensures flexible, secure, and scalable interaction with distributed infrastructure, supporting a wide range of automation scenarios.

The execution environment (EE) (280) is operatively coupled to the automation engine (260) to facilitate the execution of automation tasks. The execution environment (280) may include virtual machines, containers, or isolated runtime instances capable of hosting and running automation scripts, workflows, or executable modules. The said environment provides system-level resources such as CPU, memory, storage, and network access required for task execution.

The automation engine (260) is configured to deploy the automation tasks (t1, t2) into the execution environment (280), where they (t1, t2) are instantiated and executed. Deployment may involve transferring task definitions, scripts, or binaries from a central repository or configuration store to the execution environment. The automation engine (260) monitors task execution, collects runtime metrics, and handles error recovery or retries based on predefined policies.

The automation tasks (t1, t2) executed within the execution environment (280) are directed to one or more remote systems or target hosts (290a, 290b). Communication with these hosts (290a, 290b) is established using secure remote protocols or as defined in other embodiments. The execution environment (280) may also support sandboxing, logging, and audit capabilities to ensure secure and traceable task execution.

This configuration enables scalable, secure, and policy-driven automation across distributed infrastructure, supporting use cases such as system provisioning, configuration management, software deployment, and operational monitoring.

In an embodiment of the CAP (200f) (FIG. 5), the execution environment (280a) includes a plurality of isolated computing instances configured to execute automation tasks in a secure, scalable, and resource-controlled manner. Each instance is selected from the container (282), the virtual machine (284), or the serverless runtime (286). The container (282) provides process-level isolation using operating system-level virtualization for lightweight deployment and efficient resource sharing. The virtual machine (284) offers hardware-level isolation suitable for legacy compatibility and full-stack control. The serverless runtime (286) supports ephemeral, event-driven execution without persistent infrastructure, enabling dynamic scaling and cost-efficient operation for stateless tasks.

The execution environment (280a) enforces fine-grained isolation at the level of individual tasks, users, or workflows. The fine-grained isolation is achieved through namespace segregation, dedicated resource allocation (e.g., CPU, memory, I/O bandwidth), access control enforcement, and runtime sandboxing. These mechanisms ensure that concurrent tasks do not interfere with each other, preserving data integrity and execution determinism. The architecture supports multi-tenant scenarios, fault containment, and secure orchestration of distributed workloads across heterogeneous infrastructure.

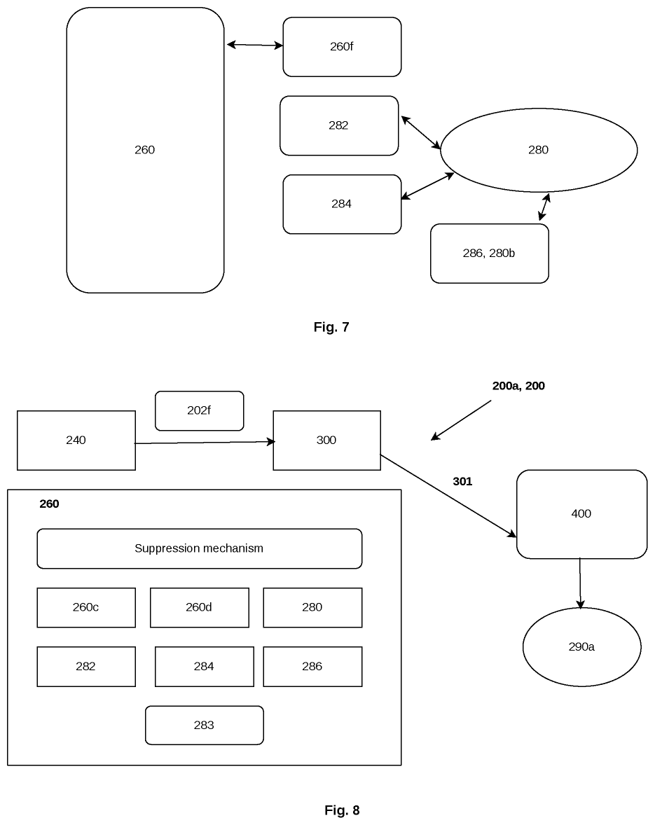

In another embodiment of the CAP (200g) (FIG. 7), the execution environment (280b) includes pre-installed automation tools and libraries required for task execution. These may include scripting engines, configuration management utilities, orchestration frameworks, diagnostic modules, and domain-specific libraries. Pre-installation eliminates the need for external dependencies or manual setup, reducing latency and improving reliability. The execution environment (280b) includes snapshotting, version control, transactional execution, automated retries, and escalation workflows. The said features ensure resilient and fault-tolerant automation across distributed systems.

In an embodiment of the cloud automation platform (200h) (FIG. 6), the target hosts (290a, 290b) (FIG. 6) include a set of computing resources selected from a cloud-based instance (292), an on-premises server (294), or an edge computing device (296). Each type of computing resource is configured to support remote execution of automation tasks and may vary in terms of network accessibility, resource availability, and operational context. The cloud-based instance (292) typically refers to a virtualized compute node provisioned within a public or private cloud infrastructure, offering elastic scalability and API-driven management. The on-premises server (294) represents a physical or virtual machine located within an enterprise data center, providing direct control over hardware and software configurations. The edge computing device (296) includes resource-constrained or specialized hardware deployed at the network edge, optimized for low-latency processing and localized task execution. In some embodiments, the one or more target hosts (290a, 290b) further include an additional target host (290c) representing a further distributed computing resource.

The target hosts (290a) are dynamically identified using either an inventory management system (299a) or a discovery service (299b). The inventory management system (299a) maintains a real-time registry of hosts with metadata such as type, location, and operational status. The discovery service (299b) performs active or passive scanning, service enumeration, or API-based querying to detect and register new or updated hosts within the automation framework. To enable selective task execution, the target hosts (290a) support tagging or grouping mechanisms (299c), allowing classification based on attributes such as function, environment, region, or workload type.

The architecture supports deployment across hybrid computing environments and multi-cloud infrastructures, combining cloud-based, on-premises, and edge resources. The said flexibility ensures scalable, fault-tolerant, and policy-driven task distribution across diverse operational domains. The automation engine (260), upon receiving a predefined command from the admin module (240), selects an appropriate execution environment (280) and identifies target hosts (290a, 290b) using the inventory management system (299a) or discovery service (299b). The hosts (290a, 290b) may include cloud-based instances (292), on-premises servers (294), or edge computing devices (296), and are filtered using tagging mechanisms (299c).

The automation engine (260) dispatches tasks to the selected hosts using secure remote communication protocols (p1, p2) ensuring secure, isolated, and monitored execution. The execution environment (280), including containers (282), virtual machines (284), or serverless runtimes (286), is selected based on task-specific requirements and is pre-configured with automation tools and libraries.

The said architecture enables consistent, context-aware automation for tasks such as provisioning virtual machines, deploying microservices, applying security patches, and collecting diagnostic logs across hybrid and multi-cloud infrastructures.

In a further embodiment of the invention (FIG. 8), a cloud automation platform (CAP) (200a) is provided. The CAP (200a) includes an API plugin (300) operatively coupling the automation engine (260) with an external system (400) via a unidirectional connection (301). The external automation identifier (202f) is for performing external automation on the target host (290a). The automation engine (260) facilitates the execution of external automation only and remains in a non-executing state when the external system (400) is performing the tasks (t1, t2). The API plugin (300) establishes the unidirectional connection (301) between the automation engine (260) and an external system (400). When an external automation identifier (202f) corresponds to an external automation task intended for execution on a target host (290a), the admin module (240) routes the predefined command through the API plugin (300) directly to the external system (400). The unidirectional connection (301) ensures that control flow and execution responsibility are transferred exclusively to the external system (400), without invoking the internal orchestration or execution modules of the automation engine (260). The said architectural design supports external automation workflows while maintaining strict separation of execution responsibilities.

To enforce non-executing state during external automation, the automation engine (260) incorporates a suppression mechanism that disables internal execution components when an external automation identifier (202f) is detected. The suppression mechanism includes deactivation of the task scheduler (260c), the dependency resolution module (260d), and the execution environment provisioning logic. The automation engine (260) also locks internal resources such as the containers (282), the virtual machines (284), and the serverless runtimes (286) to prevent unintended allocation. In an embodiment, the automation engine (260) further comprises a task registry (283) configured to record automation tasks (t1, t2) and to flag those delegated to the external system (400), thereby preventing internal scheduling or execution of such tasks during external delegation. Additionally, the task registry (283) marks externally managed tasks to prevent internal execution or scheduling. The said components collectively ensure that the automation engine (260) remains passive and in non-executing state while the external system (400) performs automation tasks (t1, t2) on the target host (290a), thereby preserving system integrity and avoiding execution conflicts.

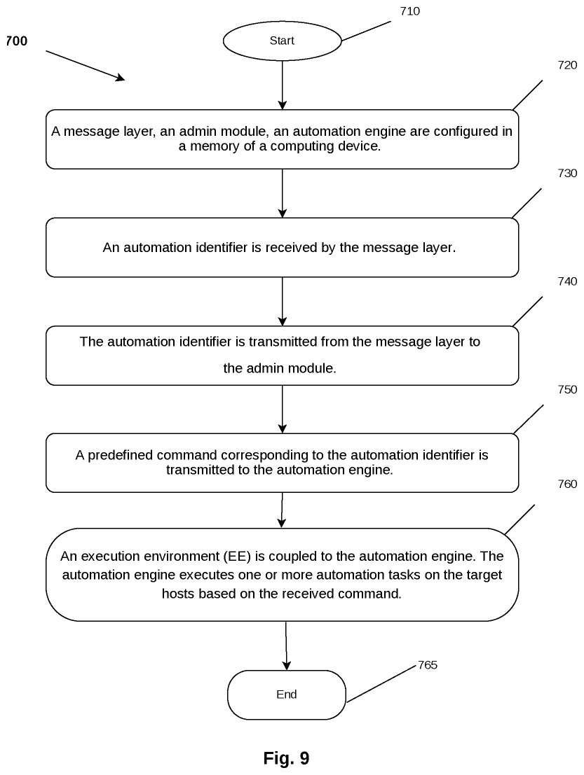

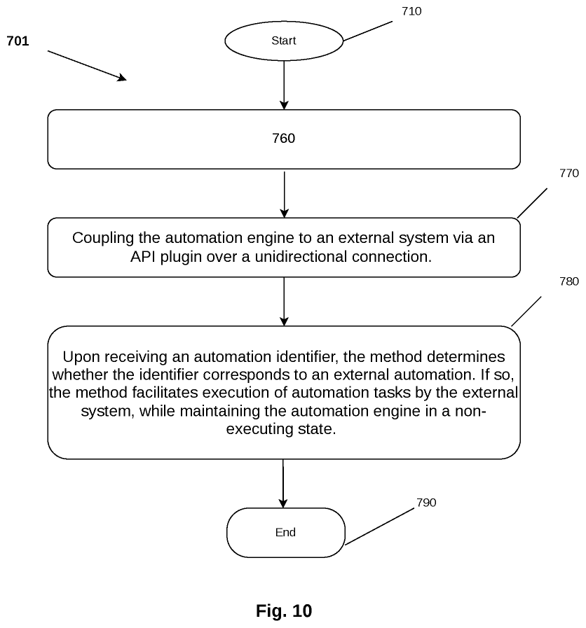

In a further embodiment of the invention (FIG. 9), a method (700) for performing the automation tasks (t1, t2) in the network-enabled computing device (C1) is provided.

The method (700) starts at step 710.

At step 720, the message layer (220), the admin module (240), the automation engine (260) are configured in the memory (m) of the computing device (C1).

At step 730, the automation identifier (202) is received by the message layer (220).

At step 740, the automation identifier (202) is transmitted from the

### Message Layer (220) to the Admin Module (240).

At step 750, a predefined command corresponding to the automation identifier (202) is transmitted to the automation engine (260).

At step 760, the execution environment (EE) (280) is coupled to the automation engine (260). The automation engine (260) executes the automation tasks (t1, t2) on the target hosts (290a, 290b) based on the received command.

The method 700 ends at the step 765.

In one embodiment of the method (701) (FIG. 10), the method (701) includes step 770, which involves coupling the automation engine (260) to an external system (400) via the API plugin (300) over the unidirectional connection (301). This connection (301) enables command transmission from the automation platform to the external system (400) while preventing bidirectional control or feedback. At step 780, upon receiving an automation identifier, the method (701) determines whether the identifier (202f) corresponds to an external automation. If so, the method (701) facilitates execution of automation tasks (t1, t2) by the external system (400), while maintaining the automation engine (260) in a non-executing state. During this state, the automation engine (260) suppresses internal task scheduling, execution environment provisioning, and monitoring functions, ensuring that task execution is exclusively managed by the external system.

The method (701) ends at step 790.

The cloud automation platform (200), implemented using the method (700), is applied in enterprise IT environments to automate infrastructure operations such as software deployment, configuration updates, and log collection. The method enables structured execution by receiving an automation identifier (202) through interfaces like dashboards, APIs, or schedulers, interpreting it via the admin module (240), and dispatching a predefined command to the automation engine (260). The automation engine, coupled with the execution environment (280), executes the task on appropriate target hosts (290a, 290b), ensuring consistent and efficient automation across cloud, on-premises, and edge systems.

In hybrid environments where external automation tools are used, the method (701) supports seamless delegation. When an automation identifier corresponds to the external task, the platform (CAP 200a) routes the command to the external system (400) via an API plugin (300) over the unidirectional connection (301). During this process, the automation engine (260) remains in non-executing state, allowing the external system to execute the task independently. This setup provides centralized control and visibility while leveraging specialized external capabilities, making it ideal for distributed automation across multiple platforms.

The cloud automation platform (200), in conjunction with the method (700), provides centralized orchestration across heterogeneous infrastructure, addressing challenges such as fragmented workflows, configuration drift, and inconsistent task execution. The automation engine (260) and execution environment (280) enable reliable task execution across virtual machines, containers, and bare-metal hosts. The message layer (220) and admin module (240) ensure secure and policy-driven command dispatch.

Scalability and adaptability are achieved through the use of isolated execution environments (280a) and intelligent task management using the task scheduler (260c) and dependency resolution module (260d). These components support concurrent execution, resource isolation, and host-specific automation, improving operational efficiency and enabling multi-tenant support.

The method (701) introduces controlled delegation to external systems (400), solving the problem of execution conflicts and tight coupling in hybrid workflows. By keeping the automation engine (260) in a non-executing state during external task execution, the method (701) reduces unnecessary resource consumption and enhances performance in high-load environments. Additional advantages include dynamic host identification, task prioritization, and integration with messaging systems, enabling precise, scalable, and secure automation across hybrid and multi-cloud infrastructures.

All third-party trademarks, service marks, trade names, or product names appearing in this specification are the property of their respective owners. They are used solely for identification, descriptive, or illustrative purposes to demonstrate interoperability or compatibility with the systems, platforms, or services referenced herein. Such use does not imply any affiliation, endorsement, or relationship between the applicant and the respective trademark owners. All rights in the referenced trademarks are hereby acknowledged.

All copyrighted materials, technical specifications, software code, and intellectual property referenced herein remain the property of their respective copyright holders. Such materials are referenced solely for technical illustration or comparative analysis without implying any license grant, authorization, or relationship between the applicant and respective owners. No copyrighted content has been reproduced or incorporated into this specification.

1. A cloud automation platform (200) comprising:
a message layer (220) configured in a network-enabled computing device (C1) having a processor (P) and a memory (m), the message layer (220) being configured to receive an automation identifier (202);
an admin module (240) configured in the memory (m) and communicatively coupled to the message layer (220), wherein the admin module (240) is configured to receive the automation identifier (202) from the message layer (220);
an automation engine (260) configured in a computing node (N), the computing node (N) being connected with the processor (P), the memory (m), and a network interface (I); the network interface (I) being communicatively coupled to the admin module (240); and
an execution environment (EE) (280) coupled to the automation engine (260), the execution environment (280) being communicatively coupled to one or more target hosts (290a, 290b) via the network interface (I), wherein the automation engine (260) is configured to execute one or more automation tasks (t1, t2) on the one or more target hosts (290a, 290b);
wherein, upon receiving the automation identifier (202), the admin module (240) transmits a predefined command corresponding to the automation identifier (202) to the automation engine (260), and the automation engine (260) executes the automation tasks (t1, t2) on the one or more target hosts (290a, 290b) based on the received command.

2. The cloud automation platform (200a) of claim 1, wherein the cloud automation platform (200a) includes an API plugin (300) operatively coupling the automation engine (260) with an external system (400) via a unidirectional connection (301), wherein, when an external-automation identifier (202f) is received for execution on a target host (290a), the API plugin (300) routes a predefined command to the external system (400), and the automation engine (260) remains in a non-executing state with respect to that external automation while the external system (400) performs the automation tasks (t1, t2); wherein the non-executing state comprises suppression of a task scheduler (260c), a dependency resolution module (260d), and execution environment provisioning logic within the automation engine (260), and locking of internal execution resources of the execution environment (280).

3. The cloud automation platform (200b) of claim 1, wherein the automation identifier (202) is received from a user interface (275a) of the cloud automation platform (200b), a machine learning module (275b), a service output (275c) of a computing activity (275d), a service input (275e) from a computing environment (275f), an API (275g), a scheduler (275h), or an external system (275i), and includes one of a task identifier (202a), a workflow identifier (202b), a script reference (202c), a policy tag (202d), or a configuration profile (202e), and the automation identifier (202) includes metadata including at least one of a task priority, a timestamp, or contextual information associated with a user initiating the automation, and wherein an external-automation identifier (202f), when present, is distinct from the task identifier (202a).

4. The cloud automation platform (200c) of claim 1, wherein the message layer (220) comprises one or more of a message queue (220a), a publish-subscribe system (220b), an event stream (220c), a message bus (220d), or an in-memory messaging system (220e), and a logic component (220f) for filtering, routing, or transforming messages, and implements a message persistence module (221) and a retry mechanism (220g); and wherein the admin module (240) comprises a rules engine (240a) configured to interpret the automation identifier (202), maintain a mapping between automation identifiers (202) and predefined automation commands, log or audit received identifiers and dispatched commands, and support role-based access control or policy enforcement.

5. The cloud automation platform (200d) of claim 1, wherein the automation engine (260) is configured to execute multiple automation tasks in a parallel computing environment (260a) or in a distributed computing environment (260b), and the automation engine (260) comprises a task scheduler (260c) or a dependency resolution module (260d) configured to determine an execution order of the automation tasks based on predefined task relationships.

6. The cloud automation platform (200e) of claim 1, wherein the automation engine (260e) is configured to communicate with the one or more target hosts (290a, 290b) using secure remote communication protocols (p1, p2).

7. The cloud automation platform (200f) of claim 1, wherein the execution environment (EE) (280a) comprises one or more isolated computing instances selected from containers (282), virtual machines (284), or serverless runtimes (286), and is configured to provide isolation at a granularity of individual tasks, users, or workflows.

8. The cloud automation platform (200g) of claim 1, wherein the execution environment (280b) includes pre-installed automation tools or libraries required for executing automation tasks.

9. The cloud automation platform (200h) of claim 1, wherein the one or more target hosts (290a, 290b) comprise computing resources selected from cloud-based instances (292), on-premises servers (294), or edge computing devices (296), wherein the one or more target hosts (290a, 290b) are identified dynamically using an inventory management system (299a) or a discovery service (299b), wherein the one or more target hosts (290a, 290b) support tagging or grouping mechanisms (299c) for task targeting;
and wherein the one or more target hosts (290a, 290b) are deployed within a hybrid computing environment or a multi-cloud infrastructure.

10. The cloud automation platform (200) of claim 5, wherein the automation engine (260) is configured to execute two or more of the automation tasks (t1, t2) in the parallel computing environment (260a) using one or more multi-core processors, a distributed memory architecture, and one or more containerized runtimes, to enable concurrent execution of the automation tasks across multiple threads or nodes.

11. The cloud automation platform (200) of claim 7, wherein the execution environment (EE) (280a) comprises a plurality of isolated computing instances configured to execute the automation tasks (t1, t2) in a resource-controlled manner, with fine-grained isolation at a level of individual tasks, users, or workflows enforced through namespace segregation and dedicated resource allocation.

12. A method (700) for performing one or more automation tasks (t1, t2) in a network-enabled computing device (C1) having a processor (P) connected to a memory (m), the computing device (C1) being communicatively coupled to one or more target hosts (290a, 290b) via a network interface (I), the method (700) comprising:
configuring a message layer (220), an admin module (240), and an automation engine (260) in the memory (m) of the computing device (C1);
receiving an automation identifier (202) by the message layer (220);
transmitting the automation identifier (202) from the message layer (220) to the admin module (240);
transmitting a predefined command corresponding to the automation identifier (202) to the automation engine (260); and
coupling an execution environment (EE) (280) to the automation engine (260), wherein the automation engine (260) executes one or more automation tasks (t1, t2) on the one or more target hosts (290a, 290b) based on the received command.

13. The method (701) of claim 12, further comprising coupling the automation engine (260) to an external system (400) via an API plugin (300) over a unidirectional connection (301), and upon determining that the automation identifier (202) corresponds to an external automation, facilitating execution of the automation tasks (t1, t2) by the external system (400) while maintaining the automation engine (260) in a non-executing state during the task execution.
